(19) United States
(12) Patent Application Publication
(10) Pub. No.: US 2011/0191516 A1
(43) Pub. Date: Aug. 4, 2011

(54) Universal touch-screen remote controller

(76) Inventors: True Xiong, San Diego, CA (US); Ling Jun Wong, Escondido, CA (US)

(21) Appl. No.: 12/658,231

(22) Filed: Feb. 4, 2010

(51) Int. Cl. G06F 3/048; G06F 3/041; G06F 3/02; G06F 13/14

(52) U.S. Cl. 710/305; 345/173; 345/168; 715/835

(57) ABSTRACT

A remote controller has a control processor and a plurality of client device remote interfaces. A touchscreen display displays a rendering depicting a remote controller user interface having user operable control elements. The processor has associated storage that stores remote controller programs that configure the touchscreen according to a remote control configuration defined by a selected remote controller programs. The processor carries out functions defined in the selected one of the remote controller programs to transmit control commands from one of said client device remote interfaces to a client device upon receipt of input via the touchscreen user interface to implement the command to the client device. This abstract is not to be considered limiting, since other embodiments may deviate from the features described in this abstract.

### COPYRIGHT AND TRADEMARK NOTICE

A portion of the disclosure of this patent document contains material which is subject to copyright protection. The copyright owner has no objection to the facsimile reproduction of the patent document or the patent disclosure, as it appears in the Patent and Trademark Office patent file or records, but otherwise reserves all copyright rights whatsoever. Trademarks are the property of their respective owners.

### BACKGROUND

With the growing number of remote controlled electronic entertainment devices in the living room, it becomes more and more imperative to keep the number of remote controllers in check. For example, a living room can have a television set (TV), accompanying home audio system, a DVD player and a Blu-ray Disc (BD) player, a Sony Playstation (PS) 3 game console, an Apple TV set top box, an Ipod with an Ipod dock, a Cable TV set top box, as well as a home automation system, giving rise to at least nine separate remote controllers. Even a modestly equipped home entertainment room can easily have four or five remote controllers or more.

Each of these devices is unique in a certain way, for example, the Apple TV™ remote control system uses wheel-like controls; an advanced home audio system requires controls to different modes of surround sound capability as well as other audio capabilities typical of an audio system; a cable TV set top box may have Internet functions and shortcut keys that is unique and different from that of an Internet-enabled television set.

The best current solution is either a standard universal hardware remote controller which operates either on Infra-Red (IR) or RF wireless such as Bluetooth, or a standard remote controller that can control multiple devices. These rigid constraints prove to be limiting in the modern world. A device, such as the Sony PlayStation 3™, relies on Bluetooth for communication does not use an IR remote controller. The cable TV set top box may require a shortcut key to access the TV guide or other customized functions. Many such features may not be supported by a conventional universal hardware remote controller.

### BRIEF DESCRIPTION OF THE DRAWINGS

Certain illustrative embodiments illustrating organization and method of operation, together with objects and advantages may be best understood by reference detailed description that follows taken in conjunction with the accompanying drawings in which:

FIG. 1 is a first example illustration of a remote controller touchscreen display configuration consistent with certain embodiments of the present invention.

FIG. 2 is a second example illustration of a remote controller touchscreen display configuration consistent with certain embodiments of the present invention.

FIG. 3 is a third example illustration of a remote controller touchscreen display configuration consistent with certain embodiments of the present invention.

FIG. 4 is a fourth example illustration of a remote controller touchscreen display configuration consistent with certain embodiments of the present invention.

FIG. 5 is an example illustration of a remote controller touchscreen display configured as a qwerty keyboard in a manner consistent with certain embodiments of the present invention.

FIG. 6 is an example illustration of a remote controller touchscreen display configured as a touchpad in a manner consistent with certain embodiments of the present invention.

FIG. 7 is an example configuration of a touchscreen display remote controller configured as a home page and depicting a USB interface in a manner consistent with certain embodiments of the present invention.

FIG. 8 is an example block diagram implementation of a touchscreen remote controller consistent with certain embodiments of the present invention.

FIG. 9 is an example block diagram of control processor built-in software consistent with certain embodiments of the present invention.

FIG. 10 is an example flow chart of a dongle installation process consistent with certain embodiments of the present invention.

FIG. 11 is an example flow chart of a process for loading a remote controller profile consistent with certain embodiments of the present invention.

FIG. 12 is an example flow chart of a process for changing remote controller profile in a manner consistent with certain embodiments of the present invention.

FIG. 13 is an example flow chart of a process for changing remote controller profile using a third party vendor's software in a manner consistent with the present invention.

FIG. 14 is an example block diagram of an illustrative software architecture used in the present remote controller in a manner consistent with certain embodiments of the present invention.

### DETAILED DESCRIPTION

While this invention is susceptible of embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings.

The terms “a” or “an”, as used herein, are defined as one or more than one. The term “plurality”, as used herein, is defined as two or more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically. The term “program” or “computer program” or “application” (“app”) or similar terms, as used herein, is defined as a sequence of instructions designed for execution on a computer system. A “program”, or “computer program”, “application”, etc. may include a subroutine, a function, a procedure, an object method, an object implementation, in an executable application, an applet, a servlet, a source code, an object code, a shared library/dynamic load library and/or other sequence of instructions designed for execution on a computer system. The term “processor”, “controller”, “control processor”, “CPU”, “Computer” and the like as used herein encompasses both hard programmed, special purpose, general purpose and programmable devices and may encompass a plurality of such devices or a single device in either a distributed or centralized configuration without limitation.

The term “program”, as used herein, may also be used in a second context (the above definition being for the first context). In the second context, the term is used in the sense of a “television program”. In this context, the term is used to mean any coherent sequence of audio video content such as those which would be interpreted as and reported in an electronic program guide (EPG) as a single television program, without regard for whether the content is a movie, sporting event, segment of a multi-part series, news broadcast, etc. The term may also be interpreted to encompass commercial spots and other program-like content which may not be reported as a program in an electronic program guide.

Reference throughout this document to “one embodiment”, “certain embodiments”, “an embodiment”, “an example”, “an implementation” or similar terms means that a particular feature, structure, or characteristic described in connection with the embodiment, example or implementation is included in at least one embodiment, example or implementation of the present invention. Thus, the appearances of such phrases or in various places throughout this specification are not necessarily all referring to the same embodiment, example or implementation. Furthermore, the particular features, structures, or characteristics may be combined in any suitable manner in one or more embodiments, examples or implementations without limitation.

The term “or” as used herein is to be interpreted as an inclusive or meaning any one or any combination. Therefore, “A, B or C” means “any of the following: A; B; C; A and B; A and C; B and C; A, B and C”. An exception to this definition will occur only when a combination of elements, functions, steps or acts are in some way inherently mutually exclusive.

As noted above, there may be a growing proliferation of remote controllers associated with various home entertainment and other electronic devices. The inventors note that there is no single universal remote controller in the marketplace that can effectively handle the wide variety of key combinations used by remote controllable devices today. The inventors further note that it does not make sense either to create a mega remote controller to accommodate all possible key combinations because it would make the device extremely cumbersome to use. Also, no matter how well-crafted a hardware universal remote controller is, the device is still only a hallmark of current available devices and cannot be future-looking.

The remote controller proposed herein provides a solution to the limitations of the traditional hardware remote controller. It not only provides a customized user experience for many if not all devices in the living room, it is also inherently an adaptable device so that changes in future devices do not require the user to change the current universal remote controller. Equipped with both IR and RF/Bluetooth capabilities, as well as a USB port or other data interface port for data transfer or dongle attachments, the software remote controller not only has the capacity for future User Interface (UI) changes, but also future technological changes.

In accord with certain implementations, the software universal remote controller is a multi functional software remote with the capacity to contain a number of different remote combinations, like for the TV, PlayStation™, third party remotes, etc. It can also be configured to double as a software keyboard, a fully functional touch pad, a fully functional tablet feature to allow users to directly draw on the screen as well as swipe feature to indicate a next/previous page. This remote control also opens up opportunities for simple games on the TV. This device can work on Bluetooth, RF, and/or IR.

The user downloads the (compatible) configurations/software of a certain remote control configuration/RC software (For purposes of this document, the terms configuration and RC software can be considered equivalent and may be used interchangeably) from a manufacturer's website or other source onto a USB device to be inserted into the USB port. The Remote Controller Manager can select the new configuration and instruct the Remote Controller Installer to install it onto the remote control. The new configuration is ready to be used right after installation. Alternatively, if the Wi-fi hardware module exists, the remote control can automatically detect a nearby Wi-fi hotspot to download the new configuration from a manufacturer's website or other source into its internal memory and can launch the Remote Controller's Manager to begin the installation process. To switch between different remote configurations, the user simply chooses it by selection of an icon from the software menu shown on the remote controller's touchscreen display.

Hence, implementations consistent with the present invention may provide some or all of the following features including, but not limited to a multi functional software remote having a full size Bluetooth keyboard in addition to a number of different remote combinations, like for the TV, PlayStation, third party remotes with the keyboard providing convenience of typing. The remote may also include a fully functional touch pad (for mouse maneuvers) to allow easy navigation on certain applications on the TV, a fully functional tablet feature to allow users to easily draw on the screen or highlight features of the screen which may be interpreted as a selection box on the receiving device and an intuitive swipe feature to indicate a next/previous page (similar to those used for photo display applications). The remote controller also opens up opportunities for simple games on the TV by virtue of emulating a game controller. The remote may also be equipped with speakers and microphone (along with associated D/A or A/D conversion and interface circuitry), to enable even more features similar to those of a cell phone (such a feature can be used to integrate with the TV, like pausing a TV program or muting the TV), as well as opening up the channel for voice activated commands. A learning remote feature can be provided to help the user to download compatible configurations of a certain remote control configuration from a manufacturer's website or elsewhere via USB or other connection, where the new configuration can be automatically installed onto the remote control and ready to be used right afterwards. The learning remote feature enables the user to switch between different remote configurations by simply choosing the configuration from the software menu shown on the remote.

In certain implementations, the programmable touch screen universal remote control is provided wherein a user can program the remote control to control a set of electronic devices by downloading remote control software appropriate for the devices to be controlled. The remote control features a keyboard application for enhancing a user's typing experience while searching content on Internet through network enabled television. Further, multiple user profiles can be created in the remote control allowing the remote control to be operated based on the preferences of the user using the remote control. User can edit Extensible Markup Language (XML) files associated with the remote control to define behavior of remote controller control elements such as user operable buttons that are rendered on the touchscreen. The user can also define which communication protocol (including communication mechanism such as Bluetooth, Infrared, RF etc.) will be used to control which device. The user can further change appearance of the remote control by rearranging remote control keys or by editing remote control layout.

In certain implementations, the remote controller can provide an on screen keyboard on a touch screen remote control for making text based entries into a Television application and can provide the ability to customize functionalities of buttons/keys of the remote control. Multiple user profiles can be created in the remote control to operate it based on preferences of user using it. The layout and appearance of keys/buttons of the touch screen remote control can be customized to the user's preference. Additionally, the user can define a communication protocol to transmit controlling commands from the remote control to control a device.

The universal touch-screen remote controller is an electronic touch-screen device which universally combines different remote controllers on a software level in order to bring out the most customized user experience for each device as well as provide additional features which a regular remote controller may lack, such as a software keyboard, while keeping to a clean single remote controller in the room.

The touchscreen remote control (RC), according to certain implementations, features a keyboard application and is programmable, upgradable with new software, and supports bluetooth as well as infrared communication. The keyboard addresses the unnatural typing experience when using Internet-enabled applications and can potentially reduce hardware redesign cost per new TV or other product.

The basic operation is as follows: Depending on what device a user has, he/she can download the appropriate remote control software including an icon asset, XML file to map name to IR/Bluetooth/RF code, events handlers or select a preinstalled specific device (PlayStation, BlueRay, A/V, etc) and launch it to control the appropriate device. User can edit the XML file, either manually or through a computer program, to change button behaviors and specify transmitter communication protocol (Bluetooth, RF, IR). User can load multiple remote control applications and is able to swap between the different applications seamlessly and easily with a touch of the touchscreen. Once a remote control profile is loaded, layout is loaded as default according to individual layout to keep the familiar user experience, but user can move or rearrange the RC buttons around, resize layout, zoom in and out and edit the layout (colors, etc) as well as changing the button's event handling behavior. When user presses the button, a vibration, which can be optionally turned off, is fed back to simulate button pressed. The zoomable display is convenient to provide an easier to read display for those who are visually impaired or those who have troubles selecting small buttons. It is noted that while the XML format is used as a configuration file in example implementations, other formats, such as a plain text file, may also be used.

In addition, the user can launch the built-in keyboard application to type. The keyboard map is preferably, but not necessarily arranged similarly to that of the smart phone as to preserve consistency of computing experience among users. User can use the touchscreen keyboard to naturally key in his/her search or log in and then switch to the specific device remote control application.

Such a remote controller can potentially centralize all device remote controls from a single manufacturer or across multiple manufacturers into one that is software-driven, which can significantly lower cost in the long term. As more and more TV manufacturers successfully integrate Internet-enabled features into the TV, it will become more complex to provide an easy to use and rich user experience, but the present remote controller can drastically simplify the process and reduce the number of remote controllers needed.

While it may be possible for TV manufacturers to stick to a certain remote control, it is definitely more flexible to have a single hardware device that can be easily updated to keep up with times. The much longer life span and the multi-functional feature of the software universal remote control easily justify any potentially increased cost.

The inventors note that the traditional remote control is limiting the advancement of the TV, simply because it is costly to change a new remote each time for a new product series of line-up. Moreover, typing intensive applications, like email applications or a cell phone texting applications (via Bluetooth), are avoided on the TV because of the limitations of the traditional remote control. A solution to this may be the use of a bluetooth keyboard, which is not only unsightly and a hindrance on the couch but also adds to the extra cost as a TV accessory. A mouse with a mouse pad on the couch is definitely out of question for a living room. A remote control with a keyboard built in adds extra costs to the TV (and extra weight on the remote controller), and this extra hardware cost is not easily justified as that remote controller is limited only to its targeted device. These extra costs could be better used by investing in a good remote control that could not only replace the functionality of these TV accessories, but also look good in the living room.

This flexibility allows the TV to progress further in its revolution so that its progress is not limited by the capabilities of the remote control. With this remote control, email typing is no longer difficult on the TV, as are searches and logins, hence opening up more features on the TV and shifting the user away from the computer to the TV, allowing the TV to retain its status as the central source of entertainment in the house.

The device can work on Bluetooth, RF or IR, but Bluetooth is considered more preferable for certain applications because of its ability to transmit more information faster as well as its compatibility to the cell phones and other devices. The battery of the remote control is preferably a standard lithium ion battery such as those used to operate the Mylo™, Iphone™, etc. The user downloads the (compatible) configurations of a certain remote control configuration from a manufacturer's website via USB. The new configuration is automatically installed onto the remote control and ready to be used right after. To switch between different remote configurations, the user simply chooses it from the software menu shown on the remote.

The remote control also contains the keyboard software application to provide convenience of typing. It acts exactly like a Bluetooth keyboard, and can be optimized to minimize the size of the LCD touch screen in certain implementations. In one example, there are several menus for the keyboard: i) The alphabet (with caps lock function key), ii) numerals, and iii) symbols. These optimizations allow the remote control to remain as small as possible because a remote control as large as a real keyboard is not only expensive, but also unsightly and hence less preferred since such a keyboard also cannot be held single-handedly in the way a familiar remote controller can.

The remote controller can include a mouse touch pad, with swipe feature similar to the touch pad on a laptop computer, the touch pad on the remote control also allows easy navigation on certain applications on the TV. Certain applications, like traversing a file system (when looking for photos) or scrolling up and down a list, provides better User Experience with a mouse-like navigation. Also the touch pad allows for a swipe feature, which could mean next or previous in an application (like a photo display app). A multi touch application can also be implemented to give an even better user experience. The entire screen can be the mouse pad itself in one implementation, while the display for a certain remote control configuration is still in use. This allows for even more convenience because the user does not have to switch between the mouse menu and the remote control menu.

Cell phone and TV interaction can be provided via Bluetooth. When the cell phone rings, the TV could respond by displaying the name of the caller as well as muting the system. At the same time, the screen on the remote control gives the user the choice to answer the phone call, as well as provide viewing access to the cell phone's address book. The user can easily scroll up and down the address book by moving the finger up and down the screen. The microphone allows the user to communicate with the caller. Internet telephone technology can also be implemented if the microphone is equipped. It is always possible to use the TV's speakers, to save on remote control costs and battery life.

Voice controls of the TV (and its accessories) can also be implemented with the microphone. There are at least three ways to do this: i) the remote control transmits the voice data to the TV which then processes it and performs the action, ii) the remote control transmits the voice data to the TV, which then processes it and returns the information to the remote control, which then uses it to perform the action. (For example, saying “dvd play”, will switch the menu on the remote control to the DVD player remote control menu and then perform the play action, which will send a play signal to the DVD player just as if the user has pressed the play button on the remote control), iii) the third way is just like the second way, but the remote control processes the voice data itself. Of these, (ii) is preferred (but not necessary) because, compared to (iii) the TV may have a more powerful processor, to save costs on the remote control processor. Also, compared to (i), (ii) is a more flexible and generic way, because it has knowledge of other devices as well, and does not require special implementation to take advantage of such knowledge as a corresponding “button press” response should already have been established, like the “play” response.

An Application Programming Interface (API) can be written so that third party manufacturers can write applications to configure the universal remote to communicate their own devices.

A universal touch-screen remote controller consistent with certain embodiments is an electronic touch-screen device which universally combines different remote controllers on a software level in order to bring out the most customized user experience for each device. With a well equipped Application Programming Interface (API) for the device, vendors will be able to create simple customized applications, such as the Ipod™ wheel, to be loaded onto the device for use as a remote controller. The software nature of the device also means that such applications could be updated in future to accommodate changes in the remote controller for the client device.

In addition to the API, native applications can also offer better features to client devices which require them. In a preferred implementation, one such feature is a full-length software keyboard. A full length software keyboard is often a better alternative to using the number pad software keyboard, but a number pad keyboard can also be provided as a native application. Other convenient native applications could include a notepad feature, and a calculator feature.

Apart from possible software/firmware improvements of the universal remote controller, USB-based add-ons are also possible for future hardware improvements. One such example is the possibility of adding Wi-fi capabilities to the device by adding a Wireless dongle and updating the remote controller device with appropriate software to utilize the add-on. This not only gives the RC device a wireless capability, but also effectively transformed it into a portable digital assistant, that is capable of sending emails.

The Application Programming Interface (API) allows applications to be developed to provide for most customized user experience. A well-developed API allows vendors to easily create applications for remote controlling purposes. An application on the remote controller typically provides a user interface (UI) that is similar to the actual hardware remote controller of the client device. Using the API, the response from the UI is translated into a suitable form of short distance data communication (currently IR or Bluetooth) that the client device can receive. This detailed level of customization provides a user experience that is not offered by the current hardwired universal remote controller in the market.

The API contains two tiers of customization. The first tier is the most basic programming interface of the remote controller, which involves the most direct interaction with the remote controller functions. Typically device manufacturers will be utilizing the API at this level to bridge the UI to the IR or Bluetooth response. The second tier utilizes the first tier to create an even more customized user interface. The average user can utilize this tier to easily configure his/her own preferred UI. In this tier, every functional control in that configuration has already been mapped to the corresponding lower level communication protocol by the device manufacturer. The user only has map their own set of controls to the corresponding controls created by the device manufacturer in the configuration.

For example, the device manufacturer may map the Volume Increase button to a certain IR code using the first tier of the API. The user may then utilize this configuration and create a different preferred image for a Volume Increase button. The user does not need to have the knowledge the corresponding IR code for the Volume Increase button; he/she only needs to know that his/her preferred image has to map to the Volume Increase button to perform that function.

In addition to the API, the universal remote controller also allows the user to pre-configure short-cuts for that device. For example, the user may create a short cut key to scroll down 5 items at a time when pressed. The short cut key consists of a simulation of several button hits on the remote control to achieve the desired functionality. In this example, the several button hits may be recorded in the following order: Down, Down, Down, Down, Down to simulate 5 Down presses when the short cut key is pressed.

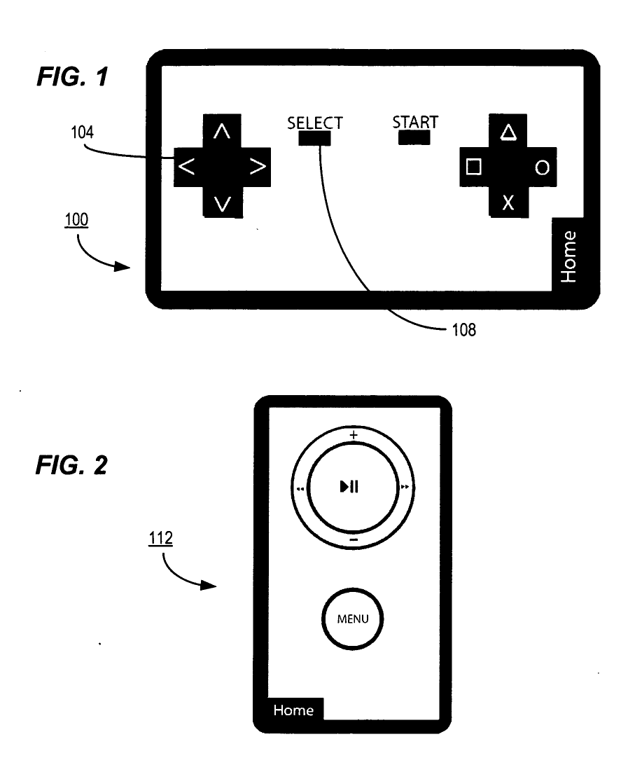

If a device configuration is unavailable for a certain device, the conventional way of recording the IR code or Bluetooth code from the device's remote controller can still be used to create a configuration file for that device. To do this, the user has to activate the learning feature on the universal remote controller, and individually map each key of the device's remote controller to a user-generated key on the universal remote controller. After creating this initial configuration file (which can be considered as Tier One in the API), the user can further customize it to his/her own preference using Tier Two of the API. FIG. 1 shows one example of how a customized application on the universal touch-screen remote controller could look and is depicted generally by 100 as a game controller as used in the Sony Playstation™ 3 (PS3™) controllers. (The PS3 controller configuration shown is mainly used for convenient navigational purposes only, as opposed to gaming purpose, since it lacks certain gaming features required by the PS3 controller.) The various control features such as the navigation buttons 104 and select button 108, for example, are displayed on a touch-screen display and operate by touch in much the same manner that the remote control feature being implemented would operate with mechanical switches. Note that as just illustrated, the remote controller functions need not be limited to just the Television and its peripherals. More specialized remote controllers, such as an Apple TV™ or Ipod™-like controllers as seen in FIG. 2 as 112. Home automation remote controllers and other controllers can also be emulated.

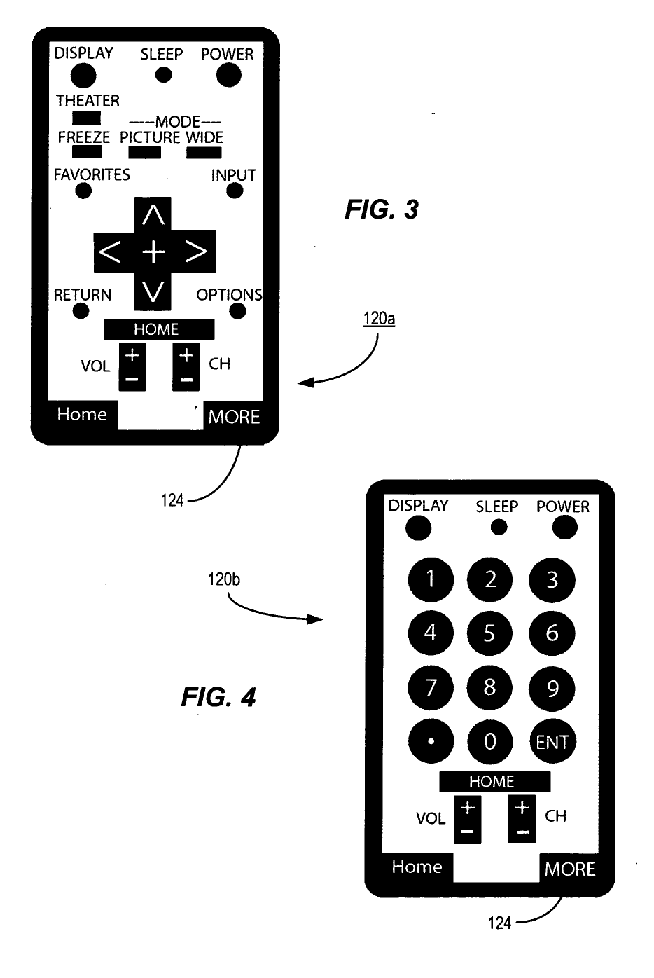

FIGS. 3 and 4 depict a television remote controller 120 (shown as 120a and 120b) such as might be used with Sony's Bravia™ line of TV sets. This remote controller broken into 2 pages. By executing the “MORE” virtual button (hereinafter “button”) 124, the application switches pages between 120a and 120b thereby permitting multiple pages of controller operation within a compact form factor. Certain global features like the “POWER”, “VOL” and “CH” buttons may be present in both (or all or multiple) pages for easy access. Note that these illustrations do not represent all the features of certain Bravia TV remote controllers but is intended to be illustrative.

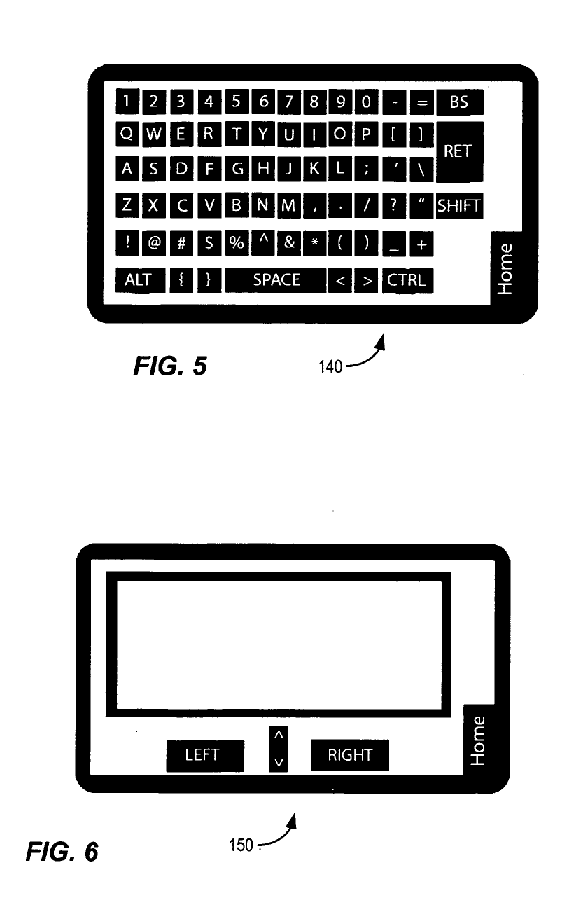

Native generic applications can be provided in order to enhance the user experience on certain client devices. One such application is depicted as keyboard 140 in FIG. 5. Native generic remote controller applications, such as a full software keyboard 140, provide a fast and cost-effective way for vendors to enhance the user experience of their devices. Vendors can easily utilize the features on this device and save on development work on their own hardware remote controller as well as on creating an extra keyboard application on this device.

The client device may not have a remote controller with a full keyboard because of the extra cost associated. However, on the software side, it may support a generic Bluetooth keyboard. The user may then utilize the software keyboard feature 140 on the client device. The layout of the keyboard is only for illustration purposes and does not necessarily reflect the best keyboard layout for all applications and other layouts could be used without departing from implementations consistent with the examples of present invention. The generic software keyboard follows the QWERTY keyboard configuration that the user is familiar with. It behaves similarly to a Bluetooth hardware keyboard, and translates the data to the compatible client device, which then interprets the IR or Bluetooth signal.

FIG. 6 depicts another example 150 in the form of a touchpad that can be provided as a native application (or as a downloadable application) for use in situations where touchpad control is desirable. With Internet capabilities reaching the living room, it is only a matter of time before users demand Internet surfing on their TV sets. Such a scenario may be expedited by a convenient wireless touchpad feature, which as noted previously can be built in to this RC device as a native application. The touchpad enables the user to control the navigation on the client device in a familiar mouse-like fashion. Touchpad 150 represents a general-purpose software touchpad that works on Bluetooth and IR, with a place to control the cursor, buttons that resemble the traditional mouse, as well as a UP/DOWN control bar to easily scroll up and down. Other configurations, of course, are possible within the scope of the present teachings. Applications like the touch pad provide an efficient tool for navigation. For home users with computers attached to the TV in the living room, these wireless keyboard and mouse applications serve as a convenient tool to reduce the mess in the living room. The generic touchpad that is installed in the device resembles the real touchpad commonly seen on a laptop computer. The touch screen tracks the finger motion as the finger moves around the screen. The action is then processed and translated to the client device which is able to receive interpret the IR or Bluetooth signal.

A microphone can also be integrated so as to provide for performing voice-related functions via Bluetooth, such as voice activation for a client device or a simple cell phone conversation with the device acting as paired headset.

Other convenient simple applications such as a notepad and a calculator can be provided by the universal touch-screen remote controller so that users do not have to have pen and paper, or a calculator within reach in the living room. The text file can be stored on a removable media such as a memory card so that the user can easily access it on some other devices. Simple games can also be installed onto this RC device if desired.

Future hardware USB-based add-ons increase the lifetime of the universal remote controller, in certain embodiments. When equipped with a USB port, or other suitable interface, future hardware add-ons can be attached to the remote controller to increase the lifetime of the device. One such example is a Wireless dongle to supply the device with a wireless capability. Needless to say, appropriate software has to be added to the device as a plug-in in order for the device to recognize and utilize the attached device. Another attachment could include a future version of the current Bluetooth technology, where the hardware with the corresponding capability can be attached as a dongle on the universal touch-screen remote controller. Again, appropriate plug-ins have to be installed on the device in order to utilize the feature.

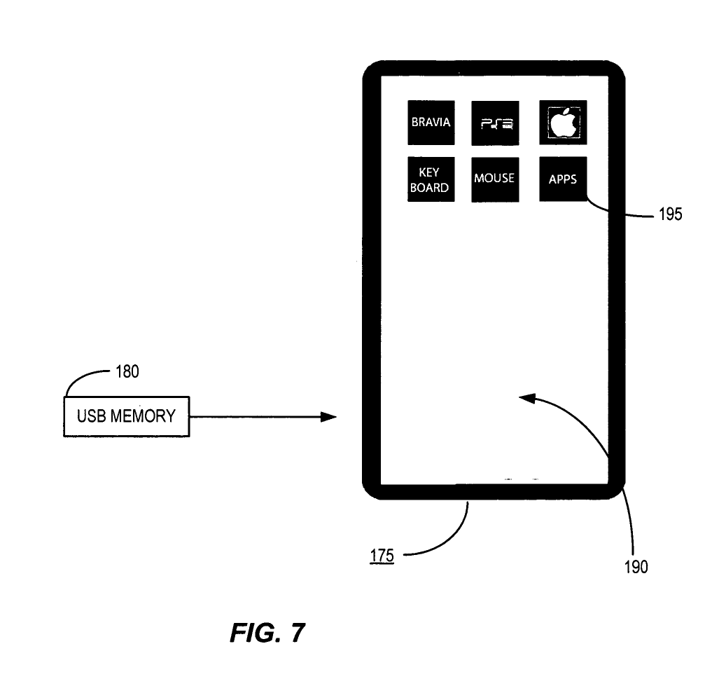

The remote controller is a simple device designed to be intuitive to the user. Adding a new application to the device is simple. The user only has to download the compatible application onto a flash memory or other storage device 180 and insert it into the USB port or other interface of the RC device (designated generally as 175), as seen in FIG. 7. The RC device 175 then automatically locates an installation program file and installs the new application. The application is then ready to use. It should be noted that such applications are not limited only to remote controller applications but also useful applications such as simple games and puzzles. Furthermore, an external USB memory or memory card can be used to store the applications and/or data. FIG. 7 illustrates the way to update/install an application onto the device as well as the home page display 190 of the RC device 175. Simply plugging in the compatible installation file installs the application onto the device. This example home page shows all the applications available on the device and provides a convenient location for the user to switch between applications. Preferably, all applications have a “HOME” key that takes the user back to this page.

Switching modes on the device is also an intuitive action. Selecting the “HOME” software key on the side of the screen, as seen in FIGS. 1-6, brings up the list of different remote configurations available in the device, for example, the Apple TV, the TV and the PS3 remote configurations as shown in FIG. 7 on home page 190 as application icons. In addition to these add-on modes, the generic modes can also appear in the list, such as the touchpad and the keyboard modes. Selecting an option will bring up the respective mode desired. For the generic modes, the user can also specify the communication channel, which is IR or Bluetooth, in this case. As more communication channels are added in the future, this list of options can grow accordingly.

Other native applications such as a notepad or a calculator that are provided in the RC device for convenience to the user so that user need not have the respective hardware available at the couch. These applications typically behave in a manner that is intuitive and familiar to the user and will be stored under the “APPS” category 195 in FIG. 7.

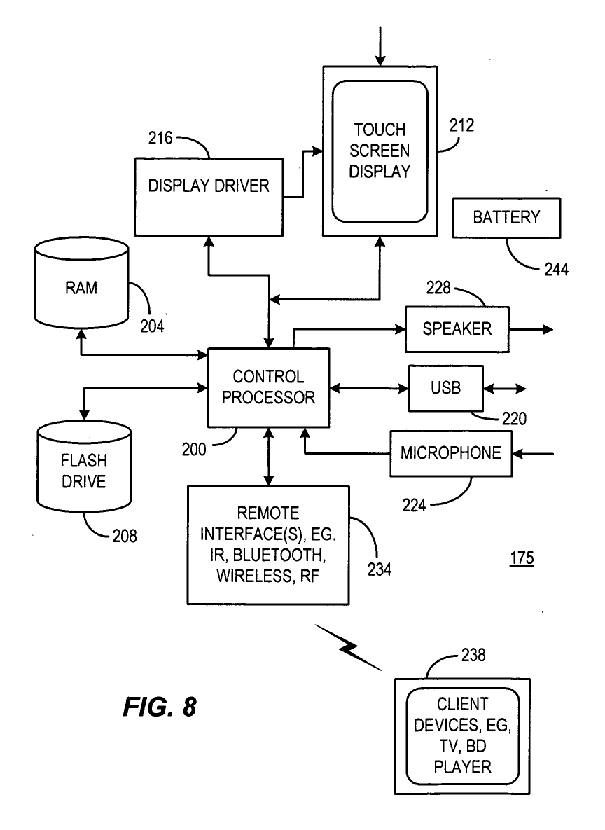

FIG. 8 depicts a block diagram of one example implementation of a touch-screen remote controller device consistent with example embodiments of the present invention shown as 175. This example is fully implemented as software processes running on control processor 200, but in equivalent embodiments, much of the hardware can be integrated into a dedicated circuit for cost and size considerations. Processor 200 can run and host a plurality of applications as described that can be stored (along with associated data) in either RAM memory 204 or Flash memory 208. ROM memory can also be provided without limitation. The connections depicted are shown as individual connections to the processor 200, but the connections may be implemented using one or more bus connections as is well understood in the art.

A touchscreen display 212 is provided as both a display element for presentation of video information to the user as well as an input device for user input by touching the display screen. The display is driven by a display driver 216, which may include a display processor, based upon information provided for display by the control processor 200. A USB or other convenient interface 220 is provided for wired communication with either a computer or other USB device such as a USB dongle or memory device. A microphone 224 and/or speaker 228 may be provided in certain implementations to facilitate voice or remote audio functionality via appropriate D/A and A/D interfaces and audio circuitry (not shown for brevity). One or more remote interfaces 234 can be provided to permit transmission of remote commands or other communication functions via Bluetooth, wireless, RF, IR or other communication protocol as is appropriate to the device being controlled. Such devices are depicted as client devices 238 including TVs, video disc players, BluRay™ disc players, home audio systems, cable boxes, etc. The RC device 175 can be powered by a battery 244 which may be rechargeable or replaceable as the designer determines.

In operation, as previously described, the user selects an application which may be a controller application for the client device and a visual representation of a controller is depicted on the touchscreen display 212. Upon actuation of a virtual button representing a command, the user's command is conveyed via an appropriate communication protocol to the client device 238 based on the program running on control processor 200.

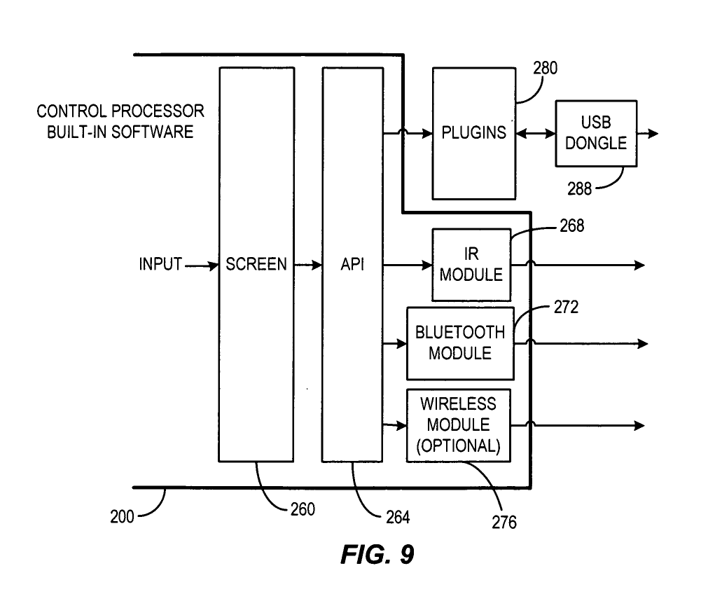

Control processor 200 may incorporate built-in software/firmware as depicted in FIG. 9. In addition to an operating system (not shown here—but portions or all can be built in), the control processor 200 can incorporate screen interface software 260, an API 264, an infrared transmitter interface module 268, a Bluetooth interface module 272 and optionally a wireless, RF or other interface modules 276. USB devices such as a USB dongle 288 that adds hardware and further functionality can be added to expand the functionality of the remote controller 175. A plug-in 280 exists outside the control processor's code in a manner similar to the way a user interface is displayed. The control processor 200's job is to simply send down information to the plugins 280 relating to the key presses from the touch screen display. It is up to the plugin to act on the information received from the processor. (This scenario can be used for any hardware outside the control processor.) It is up to the device listening, in this case the plugin, to act on the information received from the processor. In the case of the USB dongle 288, the plugin communicates with the USB dongle 288 which then sends the information out or otherwise processes the information using whatever hardware technology is being added by use of the dongle. For example, assume a new communication protocol “PurpleTooth” is not supported by the remote controller 175's internal hardware. Then a USB dongle 288 can provide the needed hardware and plugin for the communication with the control processor 200. When the unrecognized USB dongle 288 is plugged into the remote controller, the plugin stored in the USB dongle 288 will be installed into the plugin repository 280 of the remote controller. If the plugin cannot be found on the USB dongle, the user has to manually download it from the device manufacturer's website and install it into the plugin repository 280 of the remote controller via a USB memory stick. After the plugin is installed, processed information from the control processor 200 is passed on to the plugin in the plugin repository 280 which then acts on the information and dictates the response of the USB dongle with “PurpleTooth” technology. Other hardware can be handled in a similar manner. In this manner, the plugin can be used without need to modify the control processor software, enabling the hardware to have a long life without need to update the control processor's code.

In this regard, the IR module 268, Bluetooth 272 and Wireless 276 modules can be viewed as a plugin, but since its associated hardware is built in, building in the modules may provide for better performance.

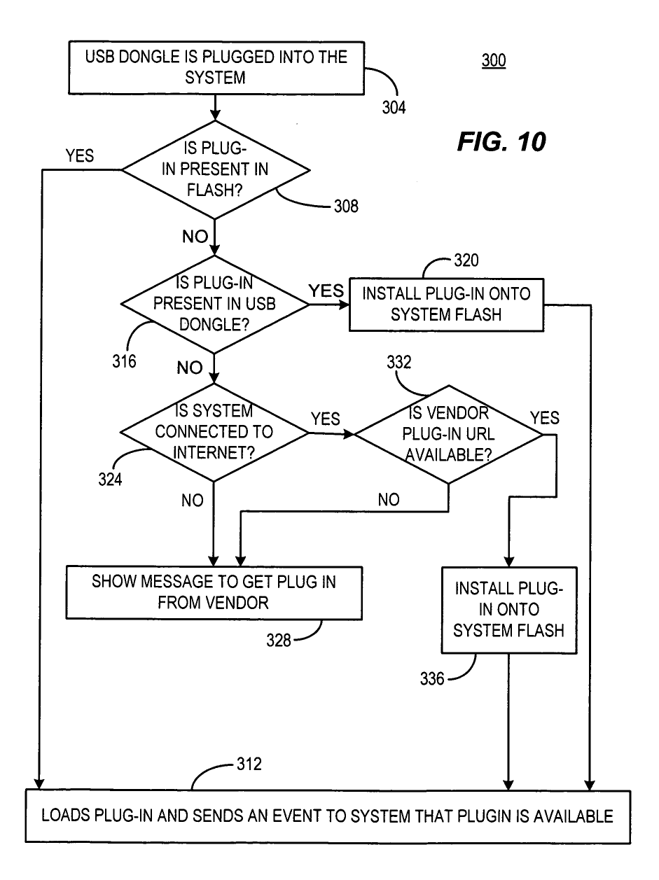

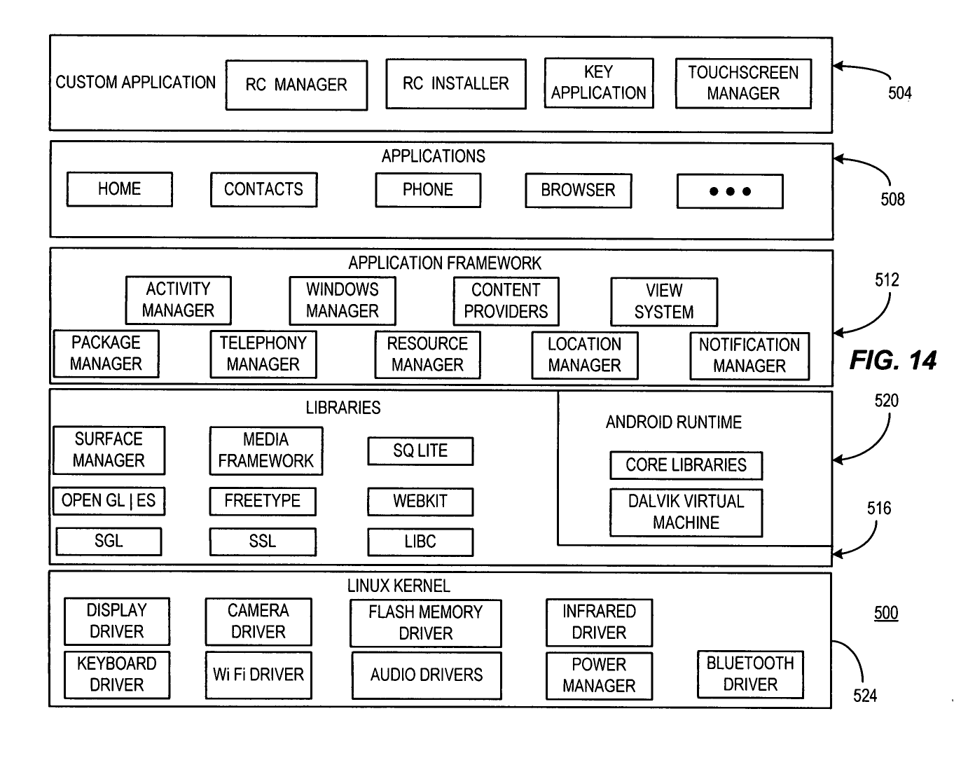

A detailed software architecture figure is provided later as FIG. 14, but those skilled in the art will understand the basic operational functions described in connection with the above-described hardware in conjunction with the basic software descriptions provided in FIGS. 10-13. These processes utilize Remote Control (RC) Manager and Remote Control (RC) installer which are implemented through the software architecture of FIG. 14.

With reference to FIG. 10, a process 300 is depicted wherein a USB dongle is plugged into the system at 304 in order to provide upgraded operation of the system by use of specialized hardware present in the dongle 288. The processor 200 determines if a software plug-in is present in the flash memory at 308, and if so the plug-in is loaded and an event is sent to the system that the plug-in is available at 312. If not, the processor 200 determines if the plug-in is present in the USB dongle at 316. If so, the plug-in is installed into the system's flash memory at 320 and control passes to 312. If not at 316, processor 200 determines if the system is connected to the Internet at 324. If not, a message is displayed at 328 to get the plug-in software from the vendor. But, if the system is connected to the Internet at 324 and a vendor plug-in URL (or URI) is available at 332, the plug-in is installed into the system flash at 336 via the Internet connection. If no URL (or URI) is available at 332, control also goes to 328 where a failure message conveys that the user should obtain the plug-in from the vendor.

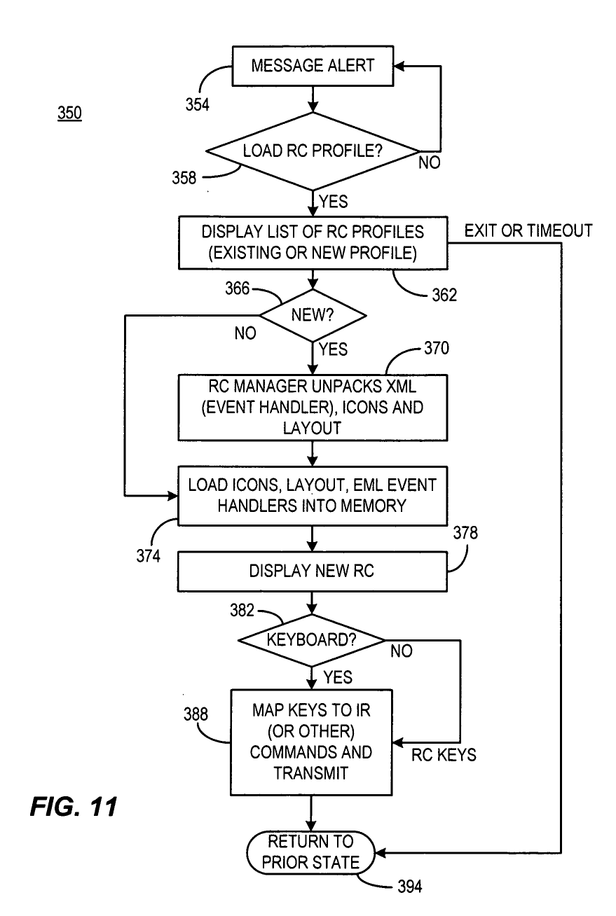

FIG. 11 depicts an example installation of a new remote controller profile as a process 350. When a message alert is generated at 354, the processor 200 determines if the alert calls for loading a new remote controller profile at 358. If not, the process continues to monitor future alerts at 354. But, if the alert calls for loading a new RC profile at 358, a listing of RC profiles (existing or new) can be displayed at 362. If a new profile is selected at 366, the RC manager unpacks the XML event handler, icons and layout associated with the new RC profile. Those icons, layout, event handles, etc. are then loaded into memory at 374 for use and the new RC layout is displayed at 378 for use by the user. If the interface uses a keyboard at 382, then the keyboard keys are mapped to IR commands (or other client interface commands) and transmitted when the keys are utilized at 388. If the keyboard is not used, the RC keys are similarly mapped to IR commands (or other client interface commands) and transmitted when the RC keys are used. At 394, the process returns to its prior state. State 394 can also be reached after an exit or timeout from 362. Additionally, if the list of RC profiles is not new (is existing) control passes directly from 366 to 374. Many variations of this process are possible without departing from implementations consistent with the present invention.

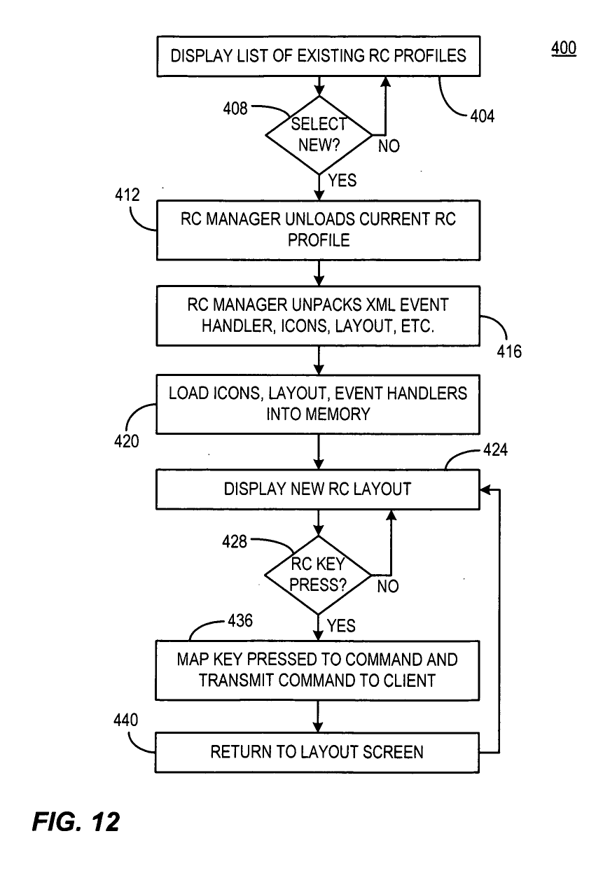

FIG. 12 depicts an example process for switching between existing remote controller profiles as process 400. At 404 the RC device 175 displays a list of existing stored RC profiles from which the user can select. At 408, there is no change in status unless the user selects a new profile, in which case the RC manager unloads any currently stored and active RC profile at 412. The RC manager then unpacks the XML event handler, icons, layout, etc. at 416 and loads the event handler, icons, layout etc. into memory at 420. The new RC layout is then displayed at 424 and ready for use by the user. When a remote control key press is detected at 428, the pressed key is mapped to a command and the command transmitted to the client at 436. At 440, the process returns to display of the RC layout at 424 and the process is repeated for any future key presses so long as the new RC layout is active.

At any point, the RC profile can be changed by the user. This is handled by execution of a key corresponding to a return to the display of existing profiles (or return to home).

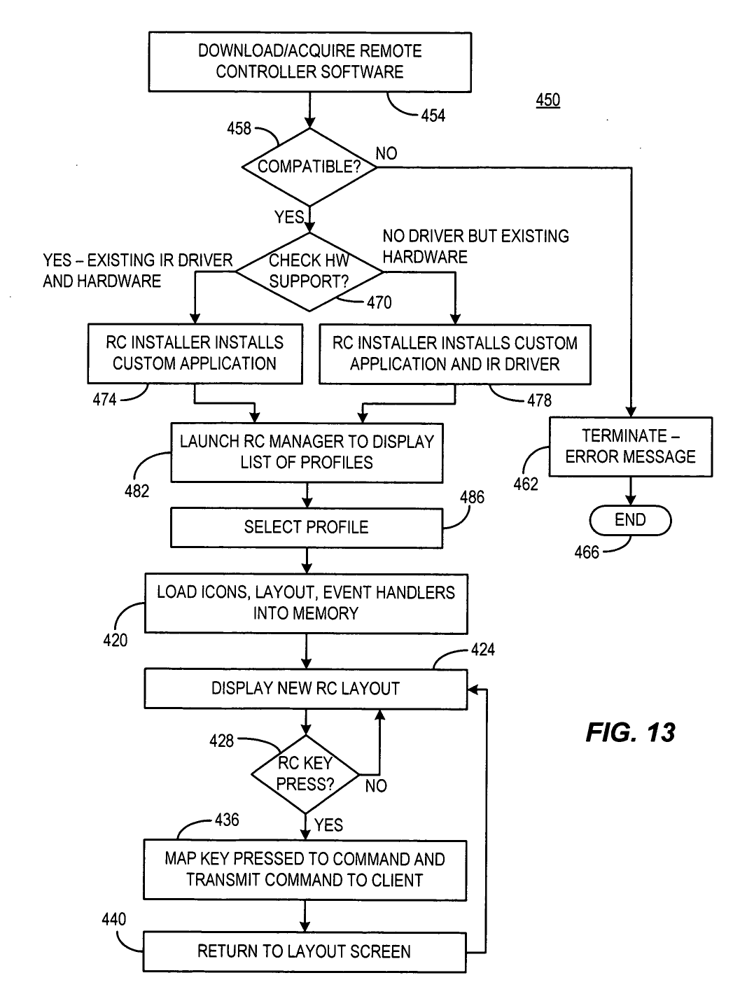

FIG. 13 depicts an example process shown as 450 of how the touchscreen remote controller can be utilized to operate client products produced by a manufacturer that is not the same as the remote controller manufacturer. In certain example implementations, the Android operating system (OS) is used as the OS for the remote controller, and this OS is referenced throughout this document as a non-limiting example. In this example process 450, use of the RC with a client product from another manufacturer can be carried out by downloading the RC software from the Internet (or otherwise providing the RC with access to the application) at 454. A compatibility check is carried out at 458 which determine at least that the application is Android operating system compatible (in this example) by the Remote Control Manager. In this example, it is presumed that the client device is controlled using infrared (IR), but can be readily extrapolated to other communication interfaces for control of a client device. If the application is not compatible at 458, the process terminates with an error message displayed at 462 and the process ends at 466.

If the application is deemed compatible at 458, the process checks to see if there is hardware support at 470. In this example, the process at 470 determines if there is existing hardware and driver for infrared communication. If so at 470, the RC installer unpacks the custom application at 474. If not at 470, in this example meaning there is no driver but there is existing (or connected) hardware, control passes to 478 where the RC installer unpacks the custom application and an IR driver. In either case, control then passes to 482 where the RC manager is launched to display a list of profiles. The user can then select a profile at 486. From this point, the process is similar to process 400, with process blocks 420, 424, 428, 436 and 440. Again, many variations will occur to those skilled in the art upon consideration of the present teachings including variations using RF, wireless, or Bluetooth or other communication interfaces and/or protocols.

Referring now to FIG. 14, an example 500 of software architecture for the present remote controller is depicted, again using the Android open source Operating System. The custom applications 504 make up a set of core applications to provide for the basic touchscreen remote control capability. The core applications include: a Remote Control Manager that acts as the “remote control” profile manager providing the backend functionality and front-end graphical user interface (GUI) for users to switch, add, remove, and edit a remote control profile (icons, XML file, layout). The Keys App provides a template which controls the layout based on a remote control profile's keyboard layout. A Touchscreen Manager allows, for example, controls for the user to calibrate the sensitivity of touches, sound enabled, zooming capability, and vibration simulation capability.

A set of core applications 508 are provided that may include any or all of an email client, SMS program, calendar, browser, phone, maps, browser, contacts, and others. Such applications can be written using the Java™ programming language.

The Application Framework 512 is an open development platform that can be used to build extremely rich and innovative applications. Developers can take advantage of the device hardware, access location information, run background services, set alarms, add notifications to the status bar, and much, much more. Underlying all applications is a set of services and systems, including but not limited to:
A rich and extensible set of Views that can be used to build an application, including lists, grids, text boxes, buttons, and even an embeddable web browser;
Content Providers that enable applications to access data from other applications (such as Contacts), or to share their own data;
A Resource Manager, providing access to non-code resources such as localized strings, graphics, and layout files;
A Notification Manager that enables all applications to display custom alerts in the status bar; and
An Activity Manager that manages the lifecycle of applications and provides a common navigation back stack.

A set of C/C++ libraries 516 used by various components of the Android system. These capabilities are exposed to developers through the Android application framework. Some of the core libraries are listed below:
System C library—a BSD-derived implementation of the standard C system library (libc), tuned for embedded Linux-based devices;
Media Libraries—based on PacketVideo's OpenCORE; the libraries support playback and recording of many popular audio and video formats, as well as static image files, including MPEG4, H.264, MP3, AAC, AMR, JPG, and PNG;
Surface Manager—manages access to the display subsystem and seamlessly composites 2D and 3D graphic layers from multiple applications;
LibWebCore—a modern web browser engine which powers both the Android browser and an embeddable web view;
SGL—the underlying 2D graphics engine;
3D libraries—an implementation based on OpenGL ES 1.0 APIs; the libraries use either hardware 3D acceleration (where available) or the included, highly optimized 3D software rasterizer;
FreeType—bitmap and vector font rendering; and
SQLite—a powerful and lightweight relational database engine available to all applications.

A set of core Android Runtime libraries 520 provides most of the functionality available in the core libraries of the Java programming language. With Android, every application runs in its own process, with its own instance of the Dalvik virtual machine (VM). Dalvik has been written so that a device can run multiple VMs efficiently. The Dalvik VM executes files in the Dalvik Executable (.dex) format which is optimized for minimal memory footprint.

A Linux Kernel 524 relies on Linux version 2.6, in the present example (but this is not to be considered limiting) for core system services such as security, memory management, process management, network stack, and driver model. The kernel also acts as an abstraction layer between the hardware and the rest of the software stack. The “infrared driver” controls the inputs from users and passes them to the hardware.

More information regarding Android can be readily found at the developer.android.com/guide/basics/what-is-android.html web address, which is hereby incorporated by reference.

This Android software architecture can provide the following features which may be advantageous individually or in combination in realizing implementations consistent with the present invention.
Application framework enabling reuse and replacement of components;
Dalvik virtual machine optimized for mobile devices;
Integrated browser based on the open source WebKit engine;
Optimized graphics powered by a custom 2D graphics library;
3D graphics based on the OpenGL ES 1.0 specification (hardware acceleration optional);
SQLite for structured data storage;
Media support for common audio, video, and still image formats (MPEG4, H.264, MP3, AAC, AMR, JPG, PNG, GIF);
GSM Telephony (hardware dependent);
Bluetooth, EDGE, 3G, and WiFi (hardware dependent); and
Camera, GPS, compass, and accelerometer (hardware dependent).

The universal touch-screen remote controller described above can serve as a useful tool to effectively reduce the number of remote controllers in the living room by offering the most customized user experience. This quality appeals more not only to the average user, but to device manufacturers as well, because it provides the intended user experience, such as the Ipod™ wheel. Even vendors like home automation manufacturers could also tap into the benefits provided this device so that it can become a central controller of home remotely controlled devices. Its generic features, such as the software keyboard, are also readily utilized by both manufacturers and consumers and permit a reduction in the hardware required. Convenient applications like notepad and calculator also ensure less mess in the living room.

Thus, a remote controller consistent with certain implementations has a control processor and a plurality of client device remote interfaces. A touchscreen display displays a rendering depicting a remote controller user interface having user operable control elements. The control processor has associated storage that stores a plurality of remote controller programs that configure the touchscreen according to a remote control configuration defined by a selected one of the plurality of remote controller programs. The control processor carries out functions defined in the selected one of the remote controller programs to transmit control commands from one of said client device remote interfaces to a client device upon receipt of input via the touchscreen user interface to implement the command to the client device. The selected one of the remote control programs transmits control commands from a selected one of the client device remote interfaces, where the selection is defined by either a user selection or by the selected one of the remote controller programs.

In certain implementations, the touchscreen display displays a plurality of icons representing the corresponding plurality remote control programs and where selection of one of the plurality of icons changes the selected one of the remote control programs. In certain implementations, a USB connector operatively coupled to the control processor for communication therewith. In certain implementations, a plugin interface, wherein the plugin interface translates messages between the USB connector and the control processor. In certain implementations, a dongle connected to the USB connector, where the dongle contains hardware that is controllable by the control processor via the plugin interface. In certain implementations, the control processor acquires one or more of the plurality of remote controller programs via the USB connector, where acquiring the remote controller programs includes retrieving icons, an event handler and a display layout. In certain implementations, the one or more remote controller programs are acquired via a connection to the Internet. In certain implementations, the one or more remote controller programs are acquired via a connection to a USB storage device. In certain implementations, the client device remote interfaces includes at least an infrared interface and a radio frequency interface. In certain implementations, the radio frequency interface includes a Bluetooth interface. In certain implementations, a speaker and a microphone are interfaced to the control processor. In certain implementations, a native keyboard application is stored in the control processor's associated storage for implementing a virtual alphabetical keyboard on the touchscreen. In certain implementations, a native touchpad application is stored in the control processor's associated storage for implementing a virtual touchpad on the touchscreen.

Another example remote controller has a control processor and a plurality of client device remote interfaces, where the client device remote interfaces include at least an infrared interface and a radio frequency interface. A touchscreen display displays a rendering depicting a remote controller user interface having user operable control elements. The control processor has associated storage that stores a plurality of remote controller programs that configure the touchscreen according to a remote control configuration defined by a selected one of the plurality of remote controller programs. The control processor carries out functions defined in the selected one of the remote controller programs to transmit control commands from one of said client device remote interfaces to a client device upon receipt of input via the touchscreen user interface to implement the command to the client device. The selected one of the remote control programs transmits control commands from a selected one of the client device remote interfaces, where the selection is defined by either a user selection or by the selected one of the remote controller programs. A USB connector operatively coupled to the control processor for communication therewith. A plugin interface is provided, wherein the plugin interface translates messages between the USB connector and the control processor. The control processor acquires one or more of the plurality of remote controller programs via the USB connector, where acquiring the remote controller programs includes retrieving icons, an event handler and a display layout. The touchscreen display displays a plurality of icons representing the corresponding plurality remote control programs and where selection of one of the plurality of icons changes the selected one of the remote control programs.

In certain implementations, a dongle connected to the USB connector, where the dongle contains hardware that is controllable by the control processor via the plugin interface. In certain implementations, the one or more remote controller programs are acquired via a connection to the Internet. In certain implementations, the one or more remote controller programs are acquired via a connection to a USB storage device. In certain implementations, the radio frequency interface includes a Bluetooth interface. In certain implementations, a speaker and a microphone are interfaced to the control processor. In certain implementations, a native keyboard application stored in the control processor's associated storage for implementing a virtual alphabetical keyboard on the touchscreen. In certain implementations, a native touchpad application stored in the control processor's associated storage for implementing a virtual touchpad on the touchscreen.

Another example remote controller has a control processor and a plurality of client device remote interfaces, where the client device remote interfaces include at least an infrared interface and a Bluetooth interface. A touchscreen display displays a rendering depicting a remote controller user interface having user operable control elements. The control processor has associated storage that stores a plurality of remote controller programs that configure the touchscreen according to a remote control configuration defined by a selected one of the plurality of remote controller programs. The control processor carries out functions defined in the selected one of the remote controller programs to transmit control commands from one of said client device remote interfaces to a client device upon receipt of input via the touchscreen user interface to implement the command to the client device. The selected one of the remote control programs transmits control commands from a selected one of the client device remote interfaces, where the selection is defined by either a user selection or by the selected one of the remote controller programs. A native keyboard application is stored in the control processor's associated storage for implementing a virtual alphabetical keyboard on the touchscreen. A native touchpad application is stored in the control processor's associated storage for implementing a virtual touchpad on the touchscreen. A USB connector is operatively coupled to the control processor for communication therewith. A plugin interface is provided, wherein the plugin interface translates messages between the USB connector and the control processor. The control processor acquires one or more of the plurality of remote controller programs via the USB connector, where acquiring the remote controller programs includes retrieving icons, an event handler and a display layout. The touchscreen display displays a plurality of icons representing the corresponding plurality remote control programs and where selection of one of the plurality of icons changes the selected one of the remote control programs.

In certain implementations, a dongle connected to the USB connector, where the dongle contains hardware that is controllable by the control processor via the plugin interface. In certain implementations, the one or more remote controller programs are acquired via either a connection to the Internet or via a connection to a USB storage device. In certain implementations, a speaker and a microphone interfaced to the control processor.

A remote controller has a control processor and a plurality of client device remote interfaces. A touchscreen display displays a rendering depicting a remote controller user interface having user operable control elements. The processor has associated storage that stores remote controller programs that configure the touchscreen according to a remote control configuration defined by a selected remote controller programs. The processor carries out functions defined in the selected one of the remote controller programs to transmit control commands from one of said client device remote interfaces to a client device upon receipt of input via the touchscreen user interface to implement the command to the client device.

Those skilled in the art will recognize, upon consideration of the above teachings, that certain of the above exemplary embodiments are based upon use of a programmed processor. However, the invention is not limited to such exemplary embodiments, since other embodiments could be implemented using hardware component equivalents such as special purpose hardware and/or dedicated processors. Similarly, general purpose computers, microprocessor based computers, micro-controllers, optical computers, analog computers, dedicated processors, application specific circuits and/or dedicated hard wired logic may be used to construct alternative equivalent embodiments.

Those skilled in the art will appreciate, upon consideration of the above teachings, that the program operations and processes and associated data used to implement certain of the embodiments described above can be implemented using disc storage as well as other forms of storage such as for example Read Only Memory (ROM) devices, Random Access Memory (RAM) devices, network memory devices, optical storage elements, magnetic storage elements, magneto-optical storage elements, flash memory, core memory and/or other equivalent volatile and non-volatile storage technologies without departing from certain embodiments of the present invention. Such alternative storage devices should be considered equivalents.

Certain embodiments described herein, are or may be implemented using a programmed processor executing programming instructions that are broadly described above in flow chart form that can be stored on any suitable electronic or computer readable storage medium. However, those skilled in the art will appreciate, upon consideration of the present teaching, that the processes described above can be implemented in any number of variations and in many suitable programming languages without departing from embodiments of the present invention. For example, the order of certain operations carried out can often be varied, additional operations can be added or operations can be deleted without departing from certain embodiments of the invention. Error trapping can be added and/or enhanced and variations can be made in user interface and information presentation without departing from certain embodiments of the present invention. Such variations are contemplated and considered equivalent.

While certain illustrative embodiments have been described, it is evident that many alternatives, modifications, permutations and variations will become apparent to those skilled in the art in light of the foregoing description.

What is claimed is:

1. A remote controller, comprising:
a control processor;
a plurality of client device remote interfaces;
a touchscreen display that displays a rendering depicting a remote controller user interface having user operable control elements;
the control processor having associated storage that stores a plurality of remote controller programs that configure the touchscreen according to a remote control configuration defined by a selected one of the plurality of remote controller programs;
where the control processor carries out functions defined in the selected one of the remote controller programs to transmit control commands from one of said client device remote interfaces to a client device upon receipt of input via the touchscreen user interface to implement the command to the client device; and
where the selected one of the remote control programs transmits control commands from a selected one of the client device remote interfaces, where the selection is defined by either a user selection or by the selected one of the remote controller programs.

2. The remote controller according to claim 1, where the touchscreen display displays a plurality of icons representing the corresponding plurality remote control programs and where selection of one of the plurality of icons changes the selected one of the remote control programs.

3. The remote controller according to claim 1, further comprising a USB connector operatively coupled to the control processor for communication therewith.

4. The remote controller according to claim 3, further comprising a plugin interface, wherein the plugin interface translates messages between the USB connector and the control processor.

5. The remote controller according to claim 3, further comprising a dongle connected to the USB connector, where the dongle contains hardware that is controllable by the control processor via the plugin interface.

6. The remote controller according to claim 3, where the control processor acquires one or more of the plurality of remote controller programs via the USB connector, where acquiring the remote controller programs includes retrieving icons, an event handler and a display layout.

7. The remote controller according to claim 6, where the one or more remote controller programs are acquired via a connection to the Internet.

8. The remote controller according to claim 6, where the one or more remote controller programs are acquired via a connection to a USB storage device.

9. The remote controller according to claim 1, wherein the client device remote interfaces includes at least an infrared interface and a radio frequency interface.

10. The remote controller according to claim 9, wherein the radio frequency interface includes a Bluetooth interface.

11. The remote controller according to claim 1, further comprising a speaker and a microphone interfaced to the control processor.

12. The remote controller according to claim 1, further comprising a native keyboard application stored in the control processor's associated storage for implementing a virtual alphabetical keyboard on the touchscreen.

13. The remote controller according to claim 1, further comprising a native touchpad application stored in the control processor's associated storage for implementing a virtual touchpad on the touchscreen.

14. A remote controller, comprising:
a control processor;
a plurality of client device remote interfaces, where the client device remote interfaces include at least an infrared interface and a radio frequency interface;
a touchscreen display that displays a rendering depicting a remote controller user interface having user operable control elements;
the control processor having associated storage that stores a plurality of remote controller programs that configure the touchscreen according to a remote control configuration defined by a selected one of the plurality of remote controller programs;
where the control processor carries out functions defined in the selected one of the remote controller programs to transmit control commands from one of said client device remote interfaces to a client device upon receipt of input via the touchscreen user interface to implement the command to the client device;
where the selected one of the remote control programs transmits control commands from a selected one of the client device remote interfaces, where the selection is defined by either a user selection or by the selected one of the remote controller programs;
a USB connector operatively coupled to the control processor for communication therewith;
a plugin interface, wherein the plugin interface translates messages between the USB connector and the control processor; and
where the control processor acquires one or more of the plurality of remote controller programs via the USB connector, where acquiring the remote controller programs includes retrieving icons, an event handler and a display layout;
where the touchscreen display displays a plurality of icons representing the corresponding plurality remote control programs and where selection of one of the plurality of icons changes the selected one of the remote control programs.

15. The remote controller according to claim 14, further comprising a dongle connected to the USB connector, where the dongle contains hardware that is controllable by the control processor via the plugin interface.

16. The remote controller according to claim 14, where the one or more remote controller programs are acquired via a connection to the Internet.

17. The remote controller according to claim 14, where the one or more remote controller programs are acquired via a connection to a USB storage device.

18. The remote controller according to claim 14, wherein the radio frequency interface includes a Bluetooth interface.

19. The remote controller according to claim 14, further comprising a speaker and a microphone interfaced to the control processor.

20. The remote controller according to claim 14, further comprising a native keyboard application stored in the control processor's associated storage for implementing a virtual alphabetical keyboard on the touchscreen.

21. The remote controller according to claim 14, further comprising a native touchpad application stored in the control processor's associated storage for implementing a virtual touchpad on the touchscreen.

22. A remote controller, comprising:
a control processor;
a plurality of client device remote interfaces, where the client device remote interfaces include at least an infrared interface and a Bluetooth interface;
a touchscreen display that displays a rendering depicting a remote controller user interface having user operable control elements;
the control processor having associated storage that stores a plurality of remote controller programs that configure the touchscreen according to a remote control configuration defined by a selected one of the plurality of remote controller programs;
where the control processor carries out functions defined in the selected one of the remote controller programs to transmit control commands from one of said client device remote interfaces to a client device upon receipt of input via the touchscreen user interface to implement the command to the client device;
where the selected one of the remote control programs transmits control commands from a selected one of the client device remote interfaces, where the selection is defined by either a user selection or by the selected one of the remote controller programs;
a native keyboard application stored in the control processor's associated storage for implementing a virtual alphabetical keyboard on the touchscreen;
a native touchpad application stored in the control processor's associated storage for implementing a virtual touchpad on the touchscreen;
a USB connector operatively coupled to the control processor for communication therewith;
a plugin interface, wherein the plugin interface translates messages between the USB connector and the control processor;
where the control processor acquires one or more of the plurality of remote controller programs via the USB connector, where acquiring the remote controller programs includes retrieving icons, an event handler and a display layout; and
where the touchscreen display displays a plurality of icons representing the corresponding plurality remote control programs and where selection of one of the plurality of icons changes the selected one of the remote control programs.

23. The remote controller according to claim 22, further comprising a dongle connected to the USB connector, where the dongle contains hardware that is controllable by the control processor via the plugin interface.

24. The remote controller according to claim 14, where the one or more remote controller programs are acquired via either a connection to the Internet or via a connection to a USB storage device.

25. The remote controller according to claim 14, further comprising a speaker and a microphone interfaced to the control processor.
